(19) United States
(12) Patent Application Publication
(10) Pub. No.: US 2016/0267586 A1
(43) Pub. Date: Sep. 15, 2016

(54) METHODS AND DEVICES FOR COMPUTING OPTIMIZED CREDIT SCORES

(71) Applicant: Tata Cousultancy Services Limited, Mumbai (IN)

(72) Inventors: Raghav MATHUR, Bangalore (IN); Rajarajan Thangavel Ramalingam, Bangalore (IN); Vandita Bansal, Bangalore (IN)

(73) Assignee: Tata Consultancy Services Limited, Mumbai (IN)

(21) Appl. No.: 15/015,576

(22) Filed: Feb. 4, 2016

(30) Foreign Application Priority Data
Mar. 9, 2015 (IN) 761/MUM/2015

(51) Int. Cl. G06Q 40/02; G06Q 50/00

(52) U.S. Cl. CPC G06Q 40/025; G06Q 50/01

(57) ABSTRACT

This disclosure relates generally to computation of credit scores, and more particularly to methods and devices for computing optimized credit scores. A computer implemented method for computing optimized credit scores comprises transmitting a data retrieval request to a data source for retrieving profile data associated with a plurality of individuals. Availability of social media data for each individual is ascertained based on corresponding profile data. Each of the plurality of individuals is classified into a first set and second set based on the availability of the social media data associated with the individual. A social media score for each individual present in the first set is determined. A social media score for each individual present in the second set is determined based on social media scores of the first set. A credit score for each individual is determined based on corresponding social media score of the individual.

### PRIORITY CLAIM

This U.S. patent application claims priority under 35 U.S.C. §119 to: India Application No. 761/MUM/2015, filed on Mar. 9, 2015. The entire contents of the aforementioned application are incorporated herein by reference.

### TECHNICAL FIELD

This disclosure relates generally to computation of credit scores, and more particularly to computing optimized credit scores.

### BACKGROUND

Organizations, such as banks, insurance companies, telecom companies, power distribution companies, and gas distribution companies, make use of credit scores associated with individuals for assessing credit risks associated with individuals. An individual with a high credit score may be classified under a low credit risk category. The credit score of an individual may be determined based on information, such as credit history, related to the individual. Typically, organizations, such as credit ranking bureaus, determine the credit scores for individuals.

The credit history of the individual comprises information, such as past loan records, past payment trends, past payment history, and transaction history, associated with the individual. In another approach, social media data associated with the individual may be utilized, in addition to the credit history, for determining the credit score of the individual. The determination of credit scores based on the social media data may improve the accuracy of determination of the credit scores of the individuals. However, determination of credit scores in accordance with this approach is limited to those individuals for whom social media data is available. Thus, this approach may not be applicable in a case where credit scores for a database comprising individuals of both types, i.e., individuals for whom social media data is available and individuals for whom social media data is not available, is to be determined.

### SUMMARY

Embodiments of the present disclosure present technological improvements as solution to the above-mentioned technical problem recognized by the inventors in conventional systems. For example, in one embodiment, a computer implemented method for computing optimized credit scores is disclosed herein. In one embodiment, a data retrieval request to a data source comprising profile data associated with a plurality of individuals for retrieving the profile data associated with the plurality of individuals may be transmitted. In another embodiment, availability of social media data for each of the plurality of individuals based on profile data associated with an individual, wherein the social media data of the individual comprises content published by the individual on one or more web-based platforms is ascertained. In yet another embodiment, each of the plurality of individuals are classified into a first set and a second set based on the availability of the social media data associated with the individual, wherein the first set of individuals are individuals for whom social media data is available, and wherein the second set of individuals are individuals for whom social media data is unavailable. In yet another embodiment, a social media score for each individual present in the first set based on the social media data of the individual and one or more scoring criteria, wherein the social media score is a cumulative score based on compliance to the one or more scoring criteria is determined. In yet another embodiment, a social media score for each individual present in the second set based on characteristics common to the characteristics of the individuals of the first set is determined. In yet another embodiment, a credit score for each of the plurality of individuals based at least on corresponding social media score of the individual is determined.

In another embodiment, a computing device for computing optimized credit scores is disclosed. In one embodiment, the computing device may comprise a processor and a classification module coupled to the processor to transmit a data retrieval request to a data source comprising profile data associated with a plurality of individuals for retrieving the profile data associated with the plurality of individuals. The classification module may ascertain availability of social media data for each of the plurality of individuals based on profile data associated with an individual, wherein the social media data of the individual comprises content published by the individual on one or more web-based platforms. And the classification module may classify each of the plurality of individuals into a first set and a second set based on the availability of the social media data associated with the individual, wherein the first set of individuals are individuals for whom social media data is available, and wherein the second set of individuals are individuals for whom social media data is unavailable. In another embodiment the computing device comprises a score computation module coupled to the processor to determine a social media score for each individual present in the first set based on the social media data of the individual and one or more scoring criteria, wherein the social media score is a cumulative score based on compliance to the one or more scoring criteria. Also the score computation module coupled to the processor may determine a social media score for each individual present in the second set based on characteristics common to the characteristics of the individuals of the first set. In yet another embodiment the score computation module coupled to the processor may determine a credit score for each of the plurality of individuals based at least on corresponding social media score of the individual.

In yet another embodiment, a computer program product comprising a non-transitory computer readable storage medium having a computer readable program stored therein is disclosed. The computer readable program, when executed on a computing device, causes the computing device to transmit a data retrieval request to a data source comprising profile data associated with a plurality of individuals for retrieving the profile data associated with the plurality of individuals. In another embodiment, the computer readable program, when executed on a computing device, causes the computing device to ascertain, by a processor, availability of social media data for each of the plurality of individuals based on profile data associated with the individual, wherein the social media data of the individual comprises content published by the individual on one or more web-based platforms. In yet another embodiment, the computer readable program, when executed on a computing device, causes the computing device to classify each of the plurality of individuals into a first set and a second set based on the availability of the social media data associated with the individual, wherein the first set of individuals are individuals for whom social media data is available, and wherein the second set of individuals are individuals for whom social media data is unavailable. In yet another embodiment the computer readable program, when executed on a computing device, causes the computing device to determine a social media score for each individual present in the first set based on the social media data of the individual and one or more scoring criteria, wherein the social media score is a cumulative score based on compliance to the one or more scoring criteria and to determine a social media score for each individual present in the second set based on characteristics common to the characteristics of the individuals of the first set and finally to determine a credit score for each of the plurality of individuals based at least on corresponding social media score of the individual.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary computing device for computing optimized credit scores according to some embodiments of the present disclosure.

FIG. 2 illustrates a method for computing optimized credit scores of the individuals based on social media data, in accordance with an embodiment of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The present subject matter relates to computing of credit scores for individuals. Credit score of an individual may be understood as an indicator, for example, a numerical expression, indicative of credit worthiness of the individual. Based on the credit score of individuals, organizations, such as banks, insurance companies, telecom companies, power distribution companies, and gas distribution companies, may assess credit risk associated with individuals. Accordingly, such organizations may decide on whether or not to engage in business with the individuals. For instance, a bank may approve or deny a loan request of an individual based on his credit score. Conventionally, organizations, such as credit ranking bureaus, determine credit scores for individuals.

The present subject matter describes methods and devices for computing optimized credit scores for a plurality of individuals. The optimized credit scores comprises enhanced or more accurate credit scores for a plurality of individuals. According to an aspect of the present subject matter, each of the plurality of individuals may be classified into a first set of individuals and a second set of individuals based on availability of corresponding social media data. For instance, individuals for whom social media data is available may be classified into the first set of individuals. Individuals for whom social media data is not available may be classified into the second set of individuals. Thereafter, a social media score corresponding to each individual present in the first set of individuals may be determined based on one or more scoring criteria and social media data corresponding to the individual. The social media score of an individual may be understood as a cumulative score determined based on the individual's compliance to one or more of the criteria. Based on the social media scores of the first set of individuals, a social media score for each individual present in the second set of individuals may be determined. Subsequently, a credit score for each of the plurality of individuals may be determined based at least on the social media score corresponding to the individual.

In accordance with an implementation of the present subject matter, a computing device, for example, a central server, deployed for computing the credit scores of individuals may retrieve profile data associated with the individuals from a plurality of database or different data sources. The profile data of an individual may include information, for example, name, age, address, occupation, telephone number, a hyperlink of a user profile hosted on a web-based portal, and e-mail address associated with the individual.

The computing device may then determine availability of social media data for each individual based on his profile data. The availability of the social media data may indicate that the social media data is available for retrieving from a corresponding web based platform on which the social media data is hosted. In other words, the social media data is said to be available if the social media data can be retrieved from the corresponding web based platform. In an example, the computing device may determine the availability of the social media data based on a hyperlink of a user profile, hosted on a web-based portal, associated with the individual. In another implementation, the computing device may determine the availability of the social media data based on an e-mail address of the individual. In yet another implementation, the computing device may determine the availability of the social media data based at least on a name, age, address, and occupation associated with the individual.

As mentioned above, based on the availability of the social media data, the computing device may classify the individuals into either the first set of individuals or the second set of individuals. Subsequently, the computing device may compute a social media score for each individual of the first set based on his corresponding social media data and the scoring criteria. For example, in accordance with one rule, the computing device may analyze the social media data to determine different types of content published by the individual. Accordingly, the computing device may determine the social media score of the individual based on the analysis of the social media data.

In an implementation, the computing device may determine the social media score for each individual of the second set of individuals based on the social media scores of the first set of individuals. For instance, for determining a social media score of an individual of the second set of individuals, the computing device may identify one or more individuals, from the first set of individuals, which have characteristics identical to that of the individual of the second set of individuals based on one or more variables. Examples of the variables may include, age, occupation, address, i.e. a region of the individuals, salary, and the like. Thereafter, the computing device may retrieve the social media scores corresponding to the identified individuals of the first set of individuals and may compute an average score based on the retrieved social media scores. The computing device may then ascertain the average score to be the social media score of the individual of the second set of individuals. As may be gathered, the computing device may compute the social media scores for the other individuals of the second set of individuals in a similar manner.

In an example, on determining the social media scores for all the individuals, the computing device may then compute the credit score for each of the individuals based at least on the social media score. For instance, the computing device may determine the credit scores based on the social media scores and the credit history of the individuals.

As may be gathered from the foregoing description, social media scores for individuals for whom social media data is not available may be determined based on social media scores of individuals for whom social media data is available. Subsequent to the determination of the social media scores, the credit scores for the individuals may be computed based on their social media scores. Thus, the present subject matter facilitates determination of credit scores based on social media data for both type of individuals, i.e., individuals for whom social media data is available and individuals for whom social media data is not available. As a result, accuracy of determination of the credit scores may increase.

These and other advantages of the present subject matter would be described in greater detail in conjunction with the following figures. While aspects of described systems and methods can be implemented in any number of different computing systems, environments, and/or configurations, the embodiments are described in the context of the following device(s).

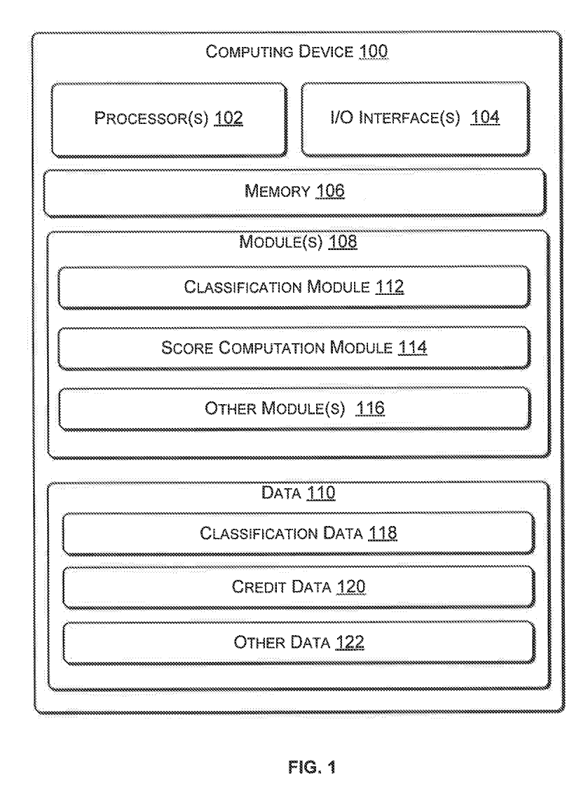

FIG. 1 illustrates a computing device 100 for determining credit scores for individuals based on social media data in accordance with an embodiment of the present disclosure. In an example, the computing device 100 may be a central server, a mainframe computer, a workstation computer, a desktop computer, and a laptop. The computing device 100 may be deployed by organizations, such as a credit scoring bureaus or third party organizations for determining credit scores for a plurality of individuals.

In an implementation, the computing device 100 may include one or more processor(s) 102, I/O interfaces 104, and a memory 106 coupled to the processor(s) 102. The processor(s) 102 can be a single processing unit or a number of units, all of which could include multiple computing units. The processor(s) 102 may be implemented as one or more microprocessors, microcomputers, microcontrollers, digital signal processors, central processing units, state machines, logic circuitries, and/or any devices that manipulate signals based on operational instructions. Among other capabilities, the processor(s) 102 is configured to fetch and execute computer-readable instructions and data stored in the memory 106.

The I/O interface(s) 104 may include a variety of software and hardware interfaces, for example, interfaces for peripheral device(s), such as a keyboard, a mouse, a display unit, an external memory, and a printer. Further, the I/O interface(s) 104 may enable the computing device 100 to communicate with other devices, such as web servers and external databases. The I/O interface(s) 104 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface(s) 104 include one or more ports for connecting a number of computing systems with one another or to a network.

The memory 106 may include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In one implementation, the computing device 100 also includes module(s) 108 and data 110. In one implementation, the module(s) 108 of the computing device 100 can be stored in the memory 106

The module(s) 108, amongst other things, include routines, programs, objects, components, data structures, etc., which perform particular tasks or implement data types. The module(s) 108 may also be implemented as, signal processor(s), state machine(s), logic circuitries, and/or any other device or component that manipulate signals based on operational instructions.

Further, the module(s) 108 can be implemented in hardware, instructions executed by a processing unit, or by a combination thereof. The processing unit can comprise a computer, a processor, such as the processor(s) 102, a state machine, a logic array or any other suitable devices capable of processing instructions. The processing unit can be a general-purpose processor which executes instructions to cause the general-purpose processor to perform the required tasks or, the processing unit can be dedicated to perform the required functions.

In another aspect of the present subject matter, the module(s) 108 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection.

In one implementation, the module(s) 108 further include a classification module 112, a score computation module 114, and other module(s) 116. The other modules 116 may include programs or coded instructions that supplement applications and functions of the computing device 100.

The data 110 serves, amongst other things, as a repository for storing data processed, received, and generated by one or more of the module(s) 108. The data 110 includes classification data 118, credit data 120, and other data 122. The other data 122 includes data generated as a result of the execution of one or more modules in the module(s) 108.

In operation, for determining optimized credit scores corresponding to the plurality of individuals, the classification module 112 may transmit a data retrieval request to a data source (not shown in the figure) comprising profile data associated with the individuals for retrieving the profile data associated with the individuals. The profile data of an individual may include a name, an address, an occupation, an age, an e-mail address, and a hyperlink to a user profile associated with the individual. The data sources may include, for example, database, data repository, storage disks, and unstructured data as well. The data source, in an example, may be located external to the computing device 100. In another example, the data source may be located within an internal storage, such as the data 110, of the computing device 100. In an example, where the data source is external to the computing device 100, the data retrieval request may be sent over a communication network (not shown in figure).

In an implementation, the classification module 112 may ascertain availability of social media data associated with each of the individuals based on the profile data corresponding to the individual. For ascertaining the availability of the social media data, the classification module 112 may initially attempt to locate a user profile associated with the individual on a web-based platform. In an example, where a hyperlink to the user profile of the individual is available, the classification module 112 may locate the user profile based on the hyperlink.

In another example, where an e-mail address associated with the individual is available, the classification module 112 may attempt to locate the user profile based on the email address. For instance, the classification module 112 may search for the user profile of the individual over a network, such as the Internet, based on the e-mail address.

In yet another example, the classification module 112 may search the internet based on credentials, such as a name, age, address, and occupation of the individual for locating the user profiles of the individual. In a case where a probable user profile comprising information similar to the credentials of the individual is identified, the classification module 112 may perform a match between the information provided in the probable user profile and the profile data of the individual. In a case where the information corresponding to the individual matches above a predetermined threshold, the classification module 112 may select the probable profile as the user profile of the individual.

Upon locating the user profile associated with the individual, the classification module 112 may seek to retrieve the social media data associated with the individual from the user profile of the individual. For retrieving the social media data, the classification module 112 may use a predetermined code or logic, such as a fuzzy logic, in an example. In a case where the classification module 112 is able to retrieve the social media data, the classification module 112 may ascertain that the social media data for the individual is available. Subsequently, the communication module 112 may store the social media data of the individual in the classification data 118.

In a case, where the classification module 112 is not able to locate a user profile of the individual, or in a case where the classification module 112 is not able to retrieve the social media data associated with the individual, the classification module 112 may ascertain that the social media data associated with the individual is not available.

Based on the availability of the social media data, the classification module 112 may classify the individuals into one of a first set of individuals and a second set of individuals. For instance, the classification module 112 may classify the individuals for whom the social media data is available into the first set of individuals. The classification module 112 may classify the individuals for whom the corresponding social media data is not available into the second set of individuals. Subsequently, the classification module 112 may store the first set of individuals and the second set of individuals in the classification data 118.

In an implementation, the score computation module 114 may compute a social media score for each individual of the first set of individuals based on social media data corresponding to the individual and one or more scoring criteria. In an example, the scoring criteria may be based on a type of content published by the individual. For instance, the scoring criteria may be based on at least one of a publishing of financial posts, a number of friends of the individual, forums and web pages subscribed by the individual, and the like. In an example, the score computation module 114 may assign scores to the individual for complying with each of the criteria. Subsequently, the score computation module 114 may cumulate the scores to obtain the social media score of the individual. As may be gathered, the score computation module 114 may compute the social media scores for the other individuals of the first set in a similar manner.

In an implementation, the score computation module 114 may compute a social media score for each individual of the second set of individuals based on the social media scores of the first set of individuals. For instance, the score computation module 114 may identify one or more individuals having identical characteristics to the individual of the second set of individuals from the first set of individuals based on one or more variables, such as name, age, address, and occupation. Thereafter, the score computation module 114 may retrieve the social media score of each of the one or more individuals. Subsequently, the score computation module 114 may compute an average score based on the social media scores of the one or more individuals. The score computation module 114 may then ascertain the average score to be the social media score of the individual of the second set of individuals. Thus, the score computation module 114 may ascertain the social media scores for the other individuals of the second set of individuals in a similar manner. Further, the score computation module 114 may store the social media scores of the plurality of individuals in the credit data 120.

On determining the social media scores of the individuals, the score computation module 114 may determine a credit score for each of the individual based at least on corresponding social media score of the individual. For example, the score computation module 114 may compute the credit score of the individual based on the social media score and the credit history of the individual. In an example, the computation module 114 may implement known techniques for determining the credit score of the individuals.

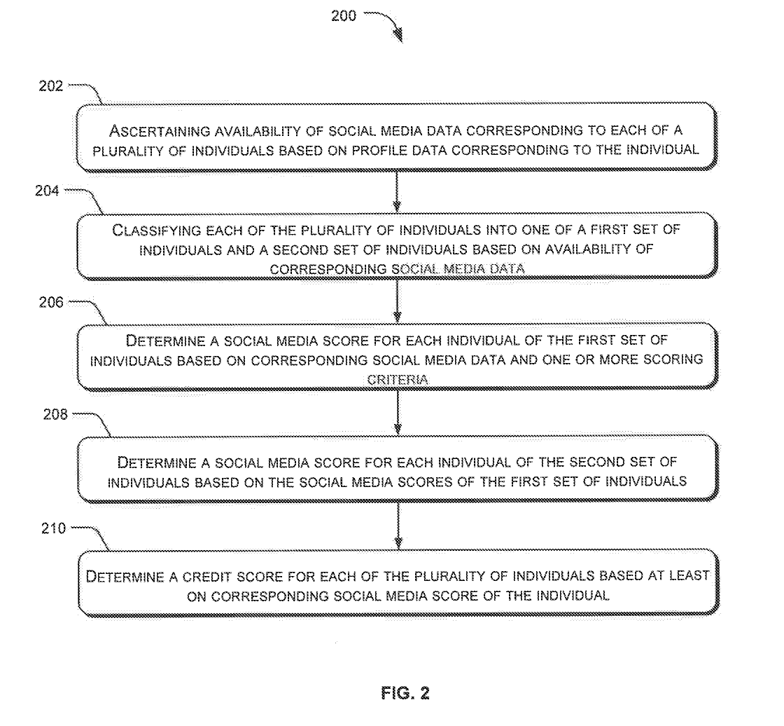

FIG. 2 illustrates a method 200 for determining credit scores for individuals based on social media data, according to an embodiment of the present subject matter. The order in which the method 200 is described is not intended to be construed as a limitation, and any number of the described method blocks can be combined in any order to implement the method or any alternative methods. Additionally, individual blocks may be deleted from the method without departing from the spirit and scope of the subject matter described herein. Furthermore, the method can be implemented in any suitable hardware, software, firmware, or combination thereof.

The method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

In an implementation, one or more of the method described herein may be implemented at least in part as instructions embodied in a non-transitory computer-readable medium and executable by one or more computing devices. In general, a processor, for example, a microprocessor, receives instructions from a non-transitory computer readable medium, for example, a memory, and executes those instructions, thereby performing one or more method, including one or more of the method described herein. Such instructions may be stored and/or transmitted using any of a variety of known computer-readable media.

Referring to FIG. 2, at block 202, availability of social media data corresponding to each of a plurality of individuals is ascertained based on profile data corresponding to the individual. Examples of the profile data of the individual data may include, but are not limited to, a name, an age, an address, an occupation, a telephone number, a hyperlink of a user profile, hosted on a web-based portal, of the individual, and an e-mail address associated with the individual. The social media data may be understood as content published by the individual on one or more web-based portals or websites. Examples of the social media data may include, status updates, posts, images, videos, support web-pages, and the like published by the individual.

Based on the profile data, a computing device, such as the computing device 100, may ascertain the availability of the social media data corresponding to each of the individuals. In an implementation, the ascertaining may be based on the hyperlink of the user profile. In another example, the ascertaining may be performed based on the e-mail address of the individual. In yet another implementation, the ascertaining may be performed based on at least one of the name, the age, the occupation, and the address of the individual.

At block 204, each of the plurality of individuals is classified into one of a first set of individuals and a second set of individuals based on availability of social media data corresponding to the individual. In an example, individuals for whom social media data is available may be classified into the first set of individuals. While, individuals for whom social media data is not available may be classified into the second set of individuals. In an example, the computing device 100 may classify the individuals into the first set and the second set.

At block 206, a social media score for each individual present in the first set of individuals is determined based on corresponding social media data and one or more scoring criteria. In accordance with an example scoring criterion, the social media score of the individual may be determined based on instances of financial activity related posts published by the individual. In accordance with another example scoring criterion, the individual may be assigned scores based on a type of social forum or group subscribed by the individual. On assigning the scores based on compliance to the scoring criteria, the social media score for the individual may be computed by cumulating the scores. In an implementation, any combination of criteria may be used for determining the social media score of the individual. In an example, the computing device 100 may determine the social media scores of the individuals of the first set.

At block 208, a social media score for each individual present in the second set of individuals is determined based on the social media scores of the first set of individuals. In an example, one or more individuals similar to the individual of the second set may be identified from amongst the individuals of the first set based on one or more variables, such as age, location, and occupation. Once the individuals similar to the individuals are identified, an average score based on their social media score may be computed. The average score may be ascertained to be the social media score of the individual. In an example, the computing device 100 may determine the social media scores for the individuals of the second set based on the social media scores of the individuals of the first set.

At block 210, a credit score for each of the plurality of individuals is determined based at least on corresponding social media score of the individual. In an example, the computing device 100 may determine the credit score based at least on the social media score. In addition, credit history of the individual may also be taken into account for determining the social media score of the individual. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A computer implemented method for computing optimized credit scores, the method comprising:
transmitting a data retrieval request to a data source comprising profile data associated with a plurality of individuals for retrieving the profile data associated with the plurality of individuals;
ascertaining availability of social media data for each of the plurality of individuals based on profile data associated with an individual therein, wherein the social media data of the individual comprises content published by the individual on one or more web-based platforms;
classifying each of the plurality of individuals into a first set and a second set based on the availability of the social media data associated with the individual, wherein the first set of individuals are individuals for whom social media data is available, and wherein the second set of individuals are individuals for whom social media data is unavailable;
determining a social media score for each individual present in the first set based on the social media data of the individual and one or more scoring criteria, wherein the social media score is a cumulative score based on compliance with one or more scoring criteria;
determining the social media score for each individual present in the second set based on characteristics common to the characteristics of the individuals of the first set; and
determining a credit score for each of the plurality of individuals based at least on corresponding social media score of the individual.

2. The method of claim 1, wherein the step of determining the social media score for each individual present in the second set of individuals comprises:
identifying one or more individuals having characteristics identical to the individual of the second set of individuals from the first set of individuals based on one or more variables;
retrieving the social media score corresponding to each of the one or more individuals;
computing an average score based on the social media scores of the one or more individuals; and
ascertaining the average score to be the social media score of the individual of the second set of individuals.

3. The method of claim 2, wherein the one or more variables comprises at least one of, an age, a location, a designation, and an occupation.

4. A computing device for computing optimized credit scores, the device comprising:
a processor;
a classification module coupled to the processor to,
transmit a data retrieval request to a data source comprising profile data associated with a plurality of individuals for retrieving the profile data associated with the plurality of individuals;
ascertain availability of social media data for each of the plurality of individuals based on profile data associated with an individual, wherein the social media data of the individual comprises content published by the individual on one or more web-based platforms;
classify each of the plurality of individuals into a first set and a second set based on the availability of the social media data associated with the individual, wherein the first set of individuals are individuals for whom social media data is available, and wherein the second set of individuals are individuals for whom social media data is unavailable; and
a score computation module coupled to the processor is further configured to,
determine a social media score for each individual present in the first set based on the social media data of the individual and one or more scoring criteria, wherein the social media score is a cumulative score based on compliance to the one or more scoring criteria;
determine a social media score for each individual present in the second set based on characteristics common to the characteristics of the individuals of the first set; and
determine a credit score for each of the plurality of individuals based at east on corresponding social media score of the individual

5. The computing device of claim 4, wherein the score computation module further is to,
identify one or more individuals having characteristics identical to the individual of the second set of individuals from the first set of individuals based on one or more variables;
retrieve a social media score corresponding to each of the one or more individuals;
compute an average score based on the social media scores of the one or more individuals; and
ascertain the average score to be the social media score of the individual of the second set of individuals.

6. The computing device of claim 5, wherein the one or more variables comprises at least one of an age, a location, a designation, and an occupation.

7. A computer program product comprising a non-transitory computer readable storage medium having a computer readable program stored therein, wherein the computer readable program, when executed on a computing device, causes the computing device to
transmit a data retrieval request to a data source comprising profile data associated with a plurality of individuals for retrieving the profile data associated with the plurality of individuals;
ascertain availability of social media data for each of the plurality of individuals based on profile data associated with the individual, wherein the social media data of the individual comprises content published by the individual on one or more web-based platforms;
classify each of the plurality of individuals into a first set and a second set based on the availability of the social media data associated with the individual, wherein the first set of individuals are individuals for whom social media data is available, and wherein the second set of individuals are individuals for whom social media data is unavailable;
determine a social media score for each individual present in the first set based on the social media data of the individual and one or more scoring criteria, wherein the social media score is a cumulative score based on compliance to the one or more scoring criteria;
determine a social media score for each individual present in the second set based on characteristics common to the characteristics of the individuals of the first set; and
determine a credit score for each of the plurality of individuals based at least on corresponding social media score of the individual.
